(19) United States
(12) Patent Application Publication
(10) Pub. No.: US 2014/0012676 A1
(43) Pub. Date: Jan. 9, 2014

(54) PROVIDING MOBILE ADVERTISING TO CONSUMERS OVER A NETWORK

(71) Applicant: Francesco Forte, Maple (CA)

(72) Inventor: Francesco Forte, Maple (CA)

(21) Appl. No.: 13/541,690

(22) Filed: Jul. 4, 2012

(51) Int. Cl. G06Q 30/02

(52) U.S. Cl. 705/14.64

(57) ABSTRACT

Data is received from an advertiser regarding a mobile advertising campaign. At least one content item is created based on the data. The content item is made accessible over a network. A mobile tag having a link is generated for the content item, the mobile advertising campaign, and/or the advertiser. The mobile tag is made available to the advertiser, who may then distribute the mobile tag. A consumer scanning the mobile tag with an electronic communication device makes a request for the content item by accessing the link. In response, access to the content item is provided over the network. The advertiser may be charged based on the consumer accessing the content item. More than one of the content items may be created for the mobile advertising campaign, and the advertiser may be charged differently based on which of the content items is provided to the consumer.

### FIELD

The present disclosure relates generally to providing advertising content to electronic communication devices.

### BACKGROUND

The following paragraphs are not an admission that anything discussed in them is prior art or part of the knowledge of persons skilled in the art.

Many mobile advertisements may not be effective because persons or organizations may not know how to create mobile advertisements that are optimized for display on electronic communication devices, or they do not have the resources to create such mobile advertisements. Some advertisers may compromise by directing an electronic mobile device to a regular website, which is not designed to be viewed on the display of a mobile device. This may turn off a potential customer, since regular website may necessitate the customer using more data or bandwidth to view, and the website may be difficult or impossible to read, either because the text is too small or items on the page may overlap.

### INTRODUCTION

The following paragraphs are intended to introduce the reader to the more detailed description that follows and not to define or limit the claimed subject matter.

According to an aspect of the present disclosure, a computer-implemented method of providing mobile advertising over a network may include: receiving data from an advertiser regarding a mobile advertising campaign; creating at least one content item based on the data, and making the at least one content item accessible over the network; generating a mobile tag including a link to the at least one content item, and making the mobile tag available to the advertiser; in response to a consumer reading the mobile tag with an electronic communication device, providing the consumer with access to the at least one content item over the network; and charging the advertiser based on the consumer accessing the at least one content item.

According to an aspect of the present disclosure, a system for providing mobile advertising over a network includes a processor, and a computer-readable storage medium storing code. The code when executed by the processor may carry out the steps of: receiving data from an advertiser regarding a mobile advertising campaign; creating at least one content item based on the data, and making the at least one content item accessible over the network; generating a mobile tag including a link to the at least one content item, and making the mobile tag available to the advertiser; in response to a consumer reading the mobile tag with an electronic communication device, providing the consumer with access to the at least one content item over the network; and charging the advertiser based on the consumer accessing the at least one content item.

According to an aspect of the present disclosure, a computer program product includes a computer-readable storage medium storing processor executable code for providing mobile advertising over a network. The code when executed may carry out the steps of: receiving data from an advertiser regarding a mobile advertising campaign; creating at least one content item based on the data, and making the at least one content item accessible over the network; generating a mobile tag including a link to the at least one content item, and making the mobile tag available to the advertiser; in response to a consumer reading the mobile tag with an electronic communication device, providing the consumer with access to the at least one content item over the network; and charging the advertiser based on the consumer accessing the at least one content item.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIG. 1 is a block diagram of various components for providing mobile advertising over a network;

FIG. 2 is a flowchart of operational steps of a computer-implemented method of managing a mobile advertising campaign;

FIG. 3 is a flowchart of operational steps of a computer-implemented method of providing content items;

FIG. 4 is a flowchart of operational steps of a computer-implemented method of confirming that the content items are received;

FIG. 5 is a flowchart of operational steps of a computer-implemented method of tracking consumer access;

FIG. 6 is a flowchart of operational steps of a computer-implemented method of tracking consumer access and selectively charging an advertiser;

FIG. 7 is a flowchart of operational steps of a computer-implemented method of receiving and storing data from an electronic communication device; and

FIG. 8 is a block diagram of data flow between components of FIG.

### DETAILED DESCRIPTION

Various apparatuses or methods will be described below to provide an example of an embodiment of each claimed invention. No embodiment described below limits any claimed invention and any claimed invention may cover systems and methods that differ from those described below. The claimed inventions are not limited to systems and methods having all of the features of any one systems or method described below or to features common to multiple or all of the apparatuses or methods described below. It is possible that a system or method described below is not an embodiment of any claimed invention. Any invention disclosed in a system or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

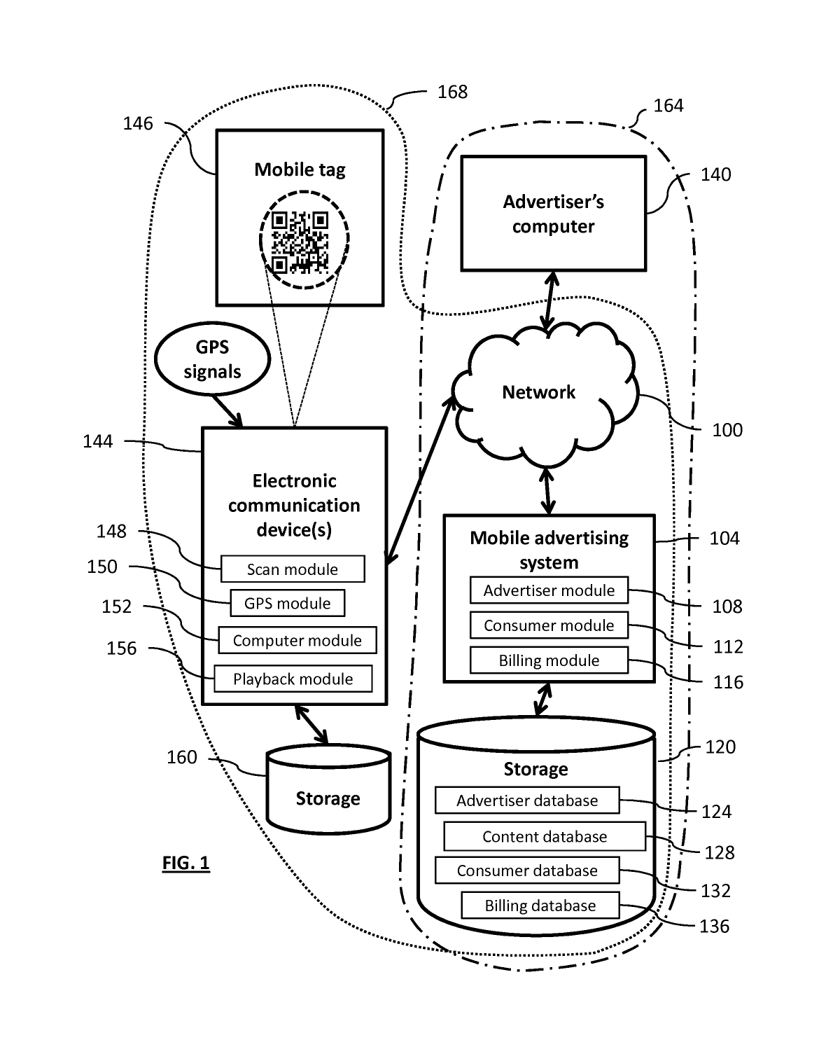

Referring to FIG. 1, a network 100 may be a network of interconnected computer systems, such as the internet. A mobile advertising system 104, an advertiser's computer 140, and at least one electronic communication device 144 of at least one consumer are connected to the network 100. It will be understood that interaction of the advertiser will be generally within the line denoted by reference numeral 164, and interaction of the consumer or customer will be generally within the line denoted by reference numeral 168.

The mobile advertising system 104 may be implemented in hardware or software, or a combination of both. Specifically, the modules of the mobile advertising system 104 may be implemented in computer programs executing on programmable computers, each including at least one processor, a data storage system, at least one input device and at least one output device. Without limitation, the programmable computers may be a mainframe computer, server, network of servers, personal computer, or laptop.

In some examples, the mobile advertising system 104 includes an advertiser module 108, a consumer module 112, and a billing module 116. Each module is configured to carry out various functions for creating a mobile advertising campaign and for providing mobile advertising over the network 100, as described herein.

At least one storage device 120 may be coupled to the mobile advertising system 104. In some examples, the storage device 120 may form part of the mobile advertising system 104, or the storage device 120 may also be implemented as a node in the network 100, remote from but connected to the mobile advertising system 104. The storage device 120 may include various databases. Some of the databases may be implemented locally, while some others may be stored remotely. In some examples, the storage device 120 includes an advertiser database 124, a content database 128, a consumer database 132 and a billing database 136.

The advertiser's computer 140 is connected to the network 100 and is in communication with the mobile advertising system 104. The advertiser's computer 140 may be any conventional computer device, such as a personal desktop computer, a laptop, a tablet, or even a smartphone. The advertiser's computer 140 should be internet-enabled. In some examples, the advertiser module 108 of the mobile advertising system 104 may generate a user interface that is displayed at the advertiser's computer 140 for interacting with the mobile advertising system 104.

The electronic communication device 144 is connected to the network 100 and is in communication with the mobile advertising system 104. In some examples, the electronic communication device 144 may be a mobile device, such as a tablet, or a smartphone. In some other examples, the electronic communication device 144 may be any conventional computer device, such as a personal desktop computer, or a laptop. In some examples, the electronic communication device 144 may consist of two or more devices, for example, a desktop and a smartphone, connected in combination.

The electronic communication device 144 is configured to scan or read a mobile tag 146. In some examples, the electronic communication device 144 includes a scan module 148 for scanning the mobile tag 146 and extracting information from the mobile tag 146. The electronic communication device 144 communicates the information to the mobile advertising system 104 via the network 100.

In some examples, the mobile tag 146 may include a 2D barcode, for example but not limited to, a QR code, or a High Capacity Color Barcode (HCCB). In some examples, the mobile tag 146 may include a Near Field Communication (NFC) tag. In some examples, the mobile tag 146 may include a computer readable image that is capable of being read by the electronic communication device 144 and associated with online content. For example, a software application for the electronic communication device 144 may be used to associate a company logo or a brand image to the link, and direct the smartphone to the link. The mobile tag 146 may be presented to the consumer in in the marketplace in various ways, including on printed material, on an electronic display, or embedded with other products.

In some examples, the electronic communication device 144 includes a GPS module 150 for receiving signals from a GPS satellite and/or wireless network, and a location of the electronic communication device 144 based on the received signals may be determined. The electronic communication device 144 may further include a computer module 152 configured to carry out necessary processing, including determining the location based on the data received by the GPS module 150, among other things.

The electronic communication device 144 also includes a playback module 156 for presenting information from the mobile advertising system 104 to the consumer. In some examples, the playback module 156 may include an internet browser.

The electronic communication device 144 may also be coupled to at least one storage device 160 for storing data. In some examples, received cookies and cached data may be stored on the storage device 160. The storage device 160 may form part of the electronic communication device 144, or the storage device 160 may be remote from but connected to the electronic communication device 144.

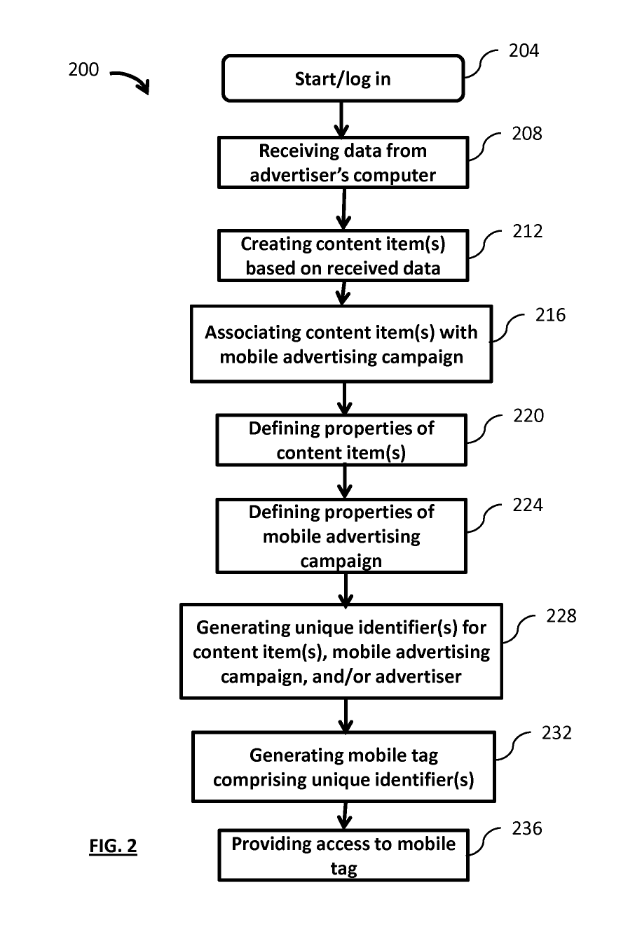

Referring now to FIG. 2, and with continued reference to FIG. 1, an example of a computer-implemented method 200 of managing the mobile advertising campaign is illustrated. The method 200 includes various steps that may be carried out by the mobile advertising system 104 of FIG. 1.

At step 204, the advertiser starts to manage the mobile advertising campaign by logging into an account from the advertiser's computer 140. The advertiser's computer 140 may send login information over the network 100 to the mobile advertising system 104. The advertiser module 108 receives the login information and may further retrieve information associated with the account of the advertiser from the advertiser database 124. Such information may include advertiser identification information, and previously created advertising campaigns.

In some examples, the advertiser module 108 may generate the user interface, which is displayed on a display of the advertiser's computer 140. The user interface may be an interactive webpage including various forms to receive input from the advertiser. For example, the user interface may display the previously created advertising campaigns associated with the advertiser's account, or prompt the advertiser to create a new mobile advertising campaign. The advertiser may choose to update a previously created mobile advertising campaign, or create the new mobile advertising campaign. The advertiser's selection is sent over the network 100 to the mobile advertising system 104. In some examples, if the advertiser chooses to update a previously created mobile advertising campaign, the mobile advertising system 104 may present a form that is populated with at least some data of the previous campaign.

At step 208, the advertiser's selection for updating or creating a mobile advertising campaign is received at the mobile advertising system 104. For updating a previously created mobile advertising campaign, the mobile advertising system 104 retrieves, for example from the advertiser database 124 and billing database 136, information related to the previously created mobile advertising campaign. For a new campaign, the mobile advertising system 104 creates a new mobile advertising campaign and stores an entry for the campaign in the advertiser database 124 and the billing database 136.

In some examples, the user interface presented at the advertiser's computer 140 may allow the advertiser to make further selections. Selections made by the advertiser through the advertiser's computer 140 may include local content and options for creating advertising content items of the mobile advertising campaign. The selected local content and options are sent as advertiser data by the advertiser's computer 140 over the network 100.

Local content may include electronic data manually entered such as text, or electronic files such as images, videos or other multimedia content. Options may include template, styles, whether to integrate various social media technologies, and whether to include a form for submitting information or making a purchase.

In some examples, the selected local content and options may be used to create various webpages for the mobile advertising campaign. The various webpages may be different versions of the same page, but that are each optimized for various types of the electronic communication device 144. In some examples, the advertiser's computer 140 may be configured to generate the different versions of the page locally, such that it may be viewed by the advertiser interacting with the advertiser's computer 140. In some examples, the different versions of the page may be generated and hosted by the mobile advertising system 104, and viewed by the advertiser interacting with the advertiser's computer 140 via the network 100.

At step 208, once the selected local content and options that were sent as data from the advertiser's computer 140 are received at the mobile advertising system 104, a verification procedure may be made to ensure that the selected local content and options are valid. In some examples, the length of submitted content may be checked to ensure it is within required length limits. In some examples, verification may be run on the mobile advertising system 104 to ensure submitted content is verified in case verification on the advertiser's computer 140 is not implemented, is bypassed, or cannot be run on the advertiser's computer for various reasons. In some examples, verification may be carried out on the advertiser's computer 140 and may provide benefits, such as improved user experience for the advertiser and reduction in additional requests to the mobile advertising system 104. Where the selected local content and options are not valid, the advertiser may be further prompted, for example, via the user interface on the advertiser's computer 140, to correct the selected local content and options or make further local content selections.

At step 212, at least one advertising content item is created or otherwise generated by the advertiser module 108 of the mobile advertising system 104, based on the data received at step 208. It will be understood that “content item” as used herein refers to any content that is intended by the advertiser to be receivable by the consumer using the electronic communication device 144. The content item may include, for example but not limited to, an image, a photograph, text, video, audio, graphics, data, sound, music, a webpage, software, information collection mechanisms (e.g., an HTML form or link for gathering consumer information, or computer code such as JavaScript for automatically collecting and submitting consumer information), or any combination thereof. The content items may be provided by third parties and, in some examples, may include a widget (e.g., a social plugin, or a “buy now” button).

The advertiser module 108 may create the content items using the received local content, and according to the selected options that were selected by the advertiser at step 204. In some examples, where the content items are webpages, the different versions of the webpage that are optimized for various types of the electronic communication device 144 may be created at step 212. Furthermore, where the content items are images or videos, lower resolution and higher resolutions versions of the images or videos may be created at step 212. The content items may be stored within the content database 128, and associated with the advertiser's account.

Each of the content items may include defined properties. In some examples, at step 216, content items may be associated with the previously created mobile advertising campaign, or a new mobile advertising campaign. Preexisting content items, for example, created for the previously created mobile advertising campaign, may also be associated with the new mobile advertising campaign. It should be appreciated that storing the content items within the content database 128 allows an advertiser to use and modify previously created content items for multiple mobile advertising campaigns. In some examples, the advertiser may select which of the content items are to be associated with which of the mobile advertising campaigns. These selections may be received as part of the data received at the mobile advertising system 104 from the advertiser's computer 140. Since the content items may be associated with the mobile advertising campaigns, identifying the mobile advertising campaign may also allow identification of the content items associated with it. In some examples, a single content item may be considered the mobile advertising campaign (e.g., a video).

At step 220, one or more additional properties of the content items may be defined. In some examples, options selected by the advertiser at the advertiser's computer 140 may further include properties for the content items. These additional properties may include ones that are not related to how content items are to be created from the local content selected and sent to the mobile advertising system 104. In some examples, these properties may include whether the content item is to be considered full-featured, limited-featured, or an intermediate degree of features. Properties of the content items may also include whether the content items are to be provided based on properties of the advertiser's account. Properties may also include the price for providing each of the content items to the electronic communication device 144. It should be appreciated that defining properties of the content items may be carried out when content items are being created. It should also be appreciated that defining properties of the mobile advertising campaign may be carried out when the content item is being created. Therefore, the order of step 212, step 216, step 220 and step 224 may be interchangeable.

In some examples, properties of the content items may be defined automatically. In some examples, whether a content item is available for one type of the electronic communication device 144 running one particular operating system, and unavailable for another type of the electronic communication device 144 running an older operating system, may be defined automatically based on the particular characteristics of the content item. For instance, the size of a particular image may dictate which type of the electronic communication device 144 it is suited for.

Some properties of the content items may be defined by the advertiser module 108 of the mobile advertising system 104. In some examples, the price charged per content item provided to the electronic communication device 144 may be dependent on the size and type of the content item, which may be determined by the advertiser module 108.

At step 224, one or more properties of the mobile advertising campaign being created are defined. In some examples, the duration of the mobile advertising campaign and the amount of credits attributed to the mobile advertising campaign may be defined by the advertiser through the user interface. Additionally, an amount of credits may also be attributed to the mobile advertiser's account globally. It will be understood that “amount of credits” is used herein to refer to billing of the advertiser's account. In some examples, the amount of credits may refer to an amount of money that an advertiser has prepaid. The amount of credits may also refer to an amount that the advertiser's account may be debited. In some examples, a credit threshold may be specified for the advertiser or the particular mobile advertising campaign, and determination of which of the content items are to be provided may be made by comparing the amount of credits with the credit threshold.

At step 228, at least one unique identifier may be generated for content items and/or the mobile advertising campaign. In some examples, the unique identifier may identify one or more specific content items. In some examples, the unique identifier may identify the mobile advertising campaign and the one or more content items associated with the campaign. In some examples, a unique identifier may also be generated for the advertiser's account if one has not already been generated. This may be advantageous where a mobile advertising campaign has expired, but the advertiser's account still exists. In such examples, even though a consumer will not be led to the advertising campaign, by having the unique identifier for the advertiser, they will at least be able to access general information about the advertiser.

The unique identifier(s) for the content items, the mobile advertising campaign, and/or the advertiser may be embedded within a link. In some examples, the link may be a uniform resource identifier, and recognizable by the internet browser of the playback module 156. When embedded within the link, the unique identifier(s) may be a series of numerals and/or characters in the link. In some examples, the series of characters may be selected to appear as being random and not allow ready identification of the advertiser of the mobile advertising campaign. In some examples, the unique identifier(s) may be in a format similar to “/23/2b”, where the alphanumeric portion after the first back slash identifies the advertiser, and the alphanumeric portion after the second backslash identifies a content item or mobile advertising campaign. In some examples, the unique identifiers may be in a query string using name value pairs, such as “a=23&c=2b” where the name “a” equates to the unique identifier for the advertiser, and the name “c” equates to the unique identifier for the content item or mobile advertising campaign. This makes the link less “guessable”, and thereby helps to prevent people from manually trying to access other content outside of the content items intended for the campaign. Furthermore, the link may include one or more unique identifiers associated with respective one or more content items, for example, in order to create a dynamic mobile website that is a collection of webpages, or a webpage with multiple items, or any combination thereof. Various configurations are possible.

At step 232, the mobile tag 146 is generated. The mobile tag 146 includes the link such that when the mobile tag is scanned by the electronic communication device 144, the link may be extracted by the electronic communication device 144. Extracting the unique identifier then allows the electronic communication device 144 to access, through the mobile advertising system 104, the content items associated with the mobile advertising campaign.

At step 236, the mobile tag 146 generated by the mobile advertising system 104 is made available to the advertiser. In some examples, in the case of a 2D barcode, the mobile tag 146 that is generated may be downloaded to the advertiser's computer 140, and may be freely printed and displayed in the marketplace at the advertiser's discretion. In the case of an NFC tag, the mobile tag 146 that is generated may be purchased through the mobile advertising system 104, or procured through a third party, and distributed by the advertiser into the marketplace.

The scan module 148 of the electronic communication device 144 retrieves the link in the mobile tag 146. By associating the content items to the mobile advertising campaign, and by embedding the unique identifier for the mobile advertising campaign within the link, the link allows the consumer to access the content items associated with the mobile advertising campaign by scanning the mobile tag 146 with the electronic communication device 144.

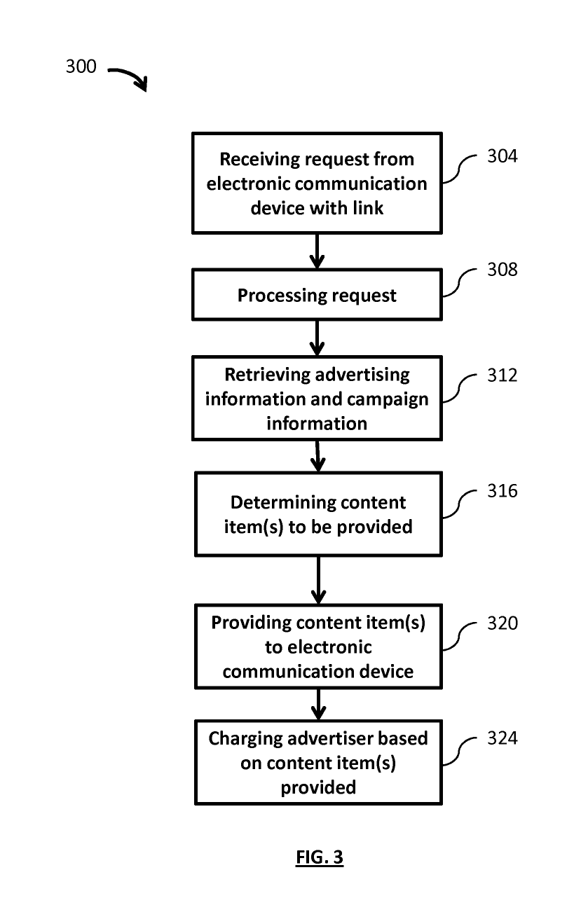

Referring now to FIG. 3, and with continued reference to FIG. 1, an example of a computer-implemented method 300 of determining which content items should be provided to an electronic communication device and providing the content items is illustrated. The method 300 includes various steps that may be carried out by the mobile advertising system 104 of FIG. 1.

At step 304, the consumer may use the electronic communication device 144 to scan and read the mobile tag 146, for example with the scan module 148. The electronic communication device 144 extracts the link, and then follows the link to be connected to the mobile advertising system 104 through the network 100. By accessing the link, the electronic communication device 144 sends a request to the mobile advertising system 104.

The mobile advertising system 104 may receive further information pertaining to the electronic communication device 144 of the consumer. In some examples, the mobile advertising system 104 may receive information regarding properties of the electronic communication device 144, including, for example but not limited to, the operating system and/or the playback module 156 (e.g., browser) of the electronic communication device 144, the version of the operating system and/or the playback module 156 of the electronic communication device 144, the manufacturer and/or model of the electronic communication device 144, the screen resolution, the bandwidth capabilities, and options such as whether the electronic communication device 144 wishes to receive limited or full-featured content. In some examples, the request may contain data from the storage device 160 on the electronic communication device 144 that may have been stored during previous communication with the mobile advertising system.

At step 308, in some examples, the mobile advertising system 104 may obtain or derive properties of the electronic communication device 144 from data provided by the electronic communication device 144. Furthermore, it may use data provided by, or obtained or derived properties from data provided by, the electronic communication device 144 to query a local database or a remote database to retrieve additional information or properties pertaining to the electronic communication device 144 or the consumer. This may be more efficient and reliable than sending a script to be run on the electronic communication device 144, which must then send back information and properties of the electronic communication device 144 to the mobile advertising system 104 as a separate request.

In some examples, properties may be derived from data by checking for matching patterns. It should be appreciated that the properties or information about the electronic communication device 144 or the consumer may be derived or obtained after receiving the request from the electronic communication device 144 in step 304, and as late as step 316 when determining the content to be provided. In some examples, data from the storage device 160 submitted in the request at step 304 may contain information regarding which mobile advertising campaigns or content items the electronic communication device 144 has previously accessed.

In some examples, the mobile advertising system 104 may determine that the electronic communication device 144 does not qualify for any content items or mobile advertising campaigns, and optionally may halt processing the request at step 308 and provide no content items. In some examples, the mobile advertising system 104 may decide that a search engine or “bot” does not qualify for any content items or mobile advertising campaigns.

The unique identifier(s) included in the link is extracted. The consumer module 112 of the mobile advertising system 104 may be configured to detect the unique identifier. In some examples, the unique identifier may identify the one or more particular content items stored by the mobile advertising system 104 to be provided to the consumer. In some examples, the unique identifier may identify the mobile advertising campaign stored by the mobile advertising system 104. Where the link also includes the unique identifier for the advertiser, the advertiser may also be identified. In some examples, the unique identifier for a content item or mobile advertising campaign may also identify an advertiser, where a query for the content item or mobile advertising campaign may also return a unique identifier for the advertiser (when the unique identifier for the advertiser is stored in the content database 128 or the advertiser database 124 in relation to the content item or mobile advertising campaign).

At step 312, information pertaining to the mobile advertising campaign identified by the unique identifier(s) may be retrieved. Information pertaining to the advertiser may also be retrieved. In some examples, such information may be received from the advertiser database 124. Information may include the advertiser's contact information, branding (e.g., text and images), templates, associated content items, amount of credits for the mobile advertising campaign, amount of credits for the advertiser's account, advertising rates, advertising rates specific to the advertiser (e.g., discounted rates), advertising rates specific to the mobile advertising campaign, credit thresholds, status (e.g., active or suspended), and custom templates.

At step 316, it is determined which of the content items identified, or associated with the identified mobile advertising campaign or the identified advertiser, should be provided or delivered to the electronic communication device 144. Which of the content items is to be provided may be determined by the advertiser module 108 of the mobile advertising system 104.

In some examples, the mobile advertising system 104 determines which of the content items of those content items associated with the campaign or advertiser are to be provided based on at least a property of electronic communication device 144. In some examples, when a request for the content items is received from the electronic communication device 144, various information about the electronic communication device 144 is also received. From this information, it may be possible to determine various properties of the electronic communication device 144, which will be relevant for determining which of the content items are to be provided to the electronic communication device 144. In some examples, the playback module 156 of the electronic communication device 144 may be configured to only play back a limited set of types of the content items. This may be due to the hardware capabilities of the electronic communication device 144 making the request, or the operating system being used by the electronic communication device 144. Accordingly, in some examples, only the content items that may be played back on the electronic communication device 144 making the request will be provided to the electronic communication device 144.

In some examples, where the content item requested is a webpage and different versions of the page have been created, for example at step 212 of the method 200, the version best suited to the capabilities of the electronic communication device 144 may be provided. Furthermore, for example, a full-featured webpage may be provided to the electronic communication device 144 having higher specifications, and a limited-featured webpage may be provided to the electronic communication device 144 having lower specifications. Moreover, where the electronic communication device 144 has a display having a maximum screen resolution, it may be determined that only images or video having a resolution below that screen resolution will be provided to the electronic communication device 144. Similarly, where the content items that are to be provided are based on the bandwidth capabilities of the electronic communication device 144, only the content items requiring lower bandwidth may be provided for some types of the electronic communication device 144, while the content items requiring higher bandwidth may be provided for other types. In some examples, where the content item requested is a webpage, a version best suited to the capabilities of the electronic communication device 144 may be created dynamically. In some examples, a content item may be created dynamically during steps 308, 312 and/or 316 where included parts of the content item may depend on information that becomes available during these steps 308, 312 and/or 316. In some examples, the mobile advertising system 104 determines which of the content items to provide in combination, or which content items to provide as part of another content item.

In some examples, where the consumer has indicated that they only wish to receive certain limited-featured content items, only the content items that are limited-featured may be provided to the electronic communication device 144. This may be the case where a consumer has used up a significant amount of their data allocation for the electronic communication device 144, and wishes to limit data use by receiving only limited-featured content items.

In some examples, the mobile advertising system 104 determines which of the content item(s) associated with the campaign or advertiser are to be provided based on a property of the account of the advertiser. The property of the account may refer specifically to the mobile advertising campaign associated with the advertiser's account, and may also refer to the advertiser's global account registered with the mobile advertising system 104. In some examples, some of the content items may be provided only if the amount of credits attributed to the mobile advertising campaign or the advertiser's account is above an amount, such as the credit threshold specified at step 224 of the method 200. This may be useful where an advertiser wishes to provide full-featured content items to the electronic communication device 144 when there are sufficient credits remaining, and to limit the content items provided to only limited-featured content items when the amount of credits falls below the credit threshold. Furthermore, it may be determined that no more credits remain that are attributed to the mobile advertising campaign, and therefore no content items should be provided. In some examples, a “page not found” content item may then be provided. Moreover, the “page not found” content item may be derived from other content item(s) or provided by the advertiser.

The advertiser may wish to attribute some credits to a particular mobile advertising campaign, and to attribute some credits globally to their account, which may be used for more than one mobile advertising campaign associated with the account. In such cases, even where the credits attributed to the mobile advertising campaign is low, credits attributed globally to the account may still be used towards providing the content items to consumers.

In some examples, it will be determined that only one of the content items is to be provided to the electronic communication device 144. However, in some examples, more than one of the content items may be provided. The combination of the content items to be provided may be dynamically selected based on one or more of the factors described herein. In some examples, where a webpage is to be provided, but the webpage also includes images and videos, it may be determined that a multimedia webpage is to be provided, but lower resolution images and videos are to be provided due to, for example, the lower screen resolution of the electronic communication device 144 making the request.

At step 320, the content items that are determined at step 316 to be provided are now delivered or otherwise provided to the electronic communication device 144 over the network 100.

At step 324, after the content items are provided to the electronic communication device 144, the advertiser's account may be charged. It will be understood that “charging” as used herein refers to applying an amount of money against the advertiser's account. Where the advertiser has prepaid for credits and attributed these credits to their account, or to one or more of the mobile advertising campaigns, charging the account may mean decreasing the amount of credits attributed to the account or mobile advertising campaigns. Alternatively, where the advertiser does not prepay for credits, or does not have any credits remaining, charging the account may mean increasing the amount debited to the account or mobile advertising campaigns. The advertiser may then be billed at a later date for the amount debited.

In some examples, the value amount charged to the advertiser's account may be based on which of the content items was provided to the electronic communication device 144. In some examples, the advertiser may be charged only after confirming that the content items were successfully received by the electronic communication device 144. In some examples, providing one content item to the electronic communication device 144 may result in the advertiser being charged a first amount, while providing another content item to the electronic communication device 144 may result in the advertiser being charged a second amount, which may be different from the first amount.

The amount to be charged may depend on the data size of the content item that is provided, where providing content items of a larger size may result in a higher value amount being charged to the advertiser. The amount to be charged may also depend on the type of content item that is provided. Some of the content items may be considered full-featured, which may include content items having more multimedia content such as videos and images. Some of the content items may be considered limited-featured, which may include content items having less multimedia content. Limited-featured content items may be only text-based, or simple webpages with lower resolution images, or lower-resolution videos. In some examples, the advertiser may be charged a higher amount when a full-featured content item is provided, and charged a lower amount, or not charged at all, when a limited-featured content item is provided.

The information related to the advertiser's billing may be stored within the billing database 136. In some examples, when advertiser information is retrieved at step 312, the advertiser's billing information may also be retrieved. The billing information may be retrieved by the billing module 116. Furthermore, when the advertiser is charged based on the content items that are provided, the advertiser's billing information may be updated. As described herein, where credits are associated with a campaign or to an advertiser and are indicated in the advertiser billing information, the billing information may be updated by decreasing the credits available, or increasing an amount owing.

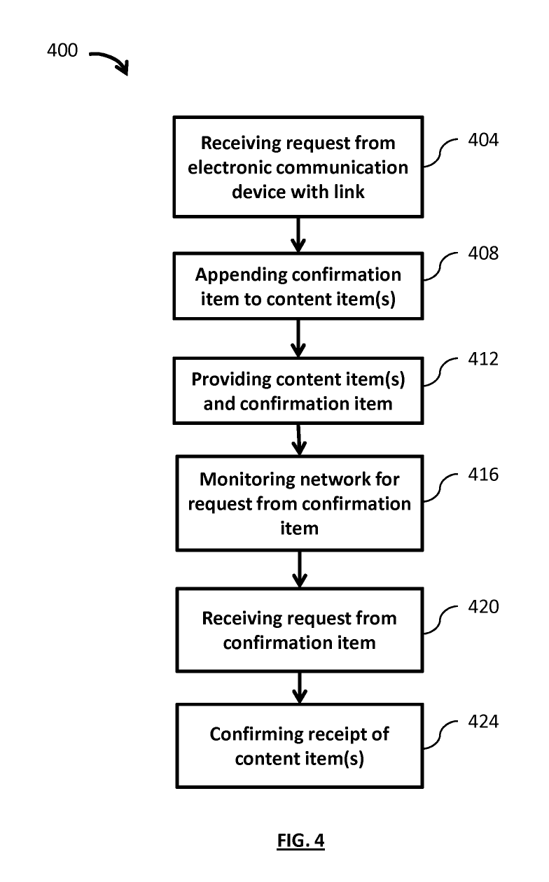

Referring now to FIG. 4, and with continued reference to FIG. 1, an example of a computer-implemented method 400 of confirming receipt of the content items is illustrated. The method 400 includes various steps that may be carried out by the mobile advertising system 104 of FIG. 1.

At step 404, a request for the content items may be received. In some examples, the request may be the link extracted from the mobile tag 146 that has the unique identifier(s) of the content item(s), the mobile advertising campaign, and/or the advertiser. The request received at step 404 may be similar to the request received at step 304 of the method 300. The request may be received by the mobile advertising system 104 over the network 100.

At step 408, one or more confirmation items may be appended to the content items to be provided to the electronic communication device 144. The content items to be provided to the electronic communication device 144 may be determined generally according to the method 300. The confirmation item(s) may be appended by the advertiser module 108 of the mobile advertising system 104.

The confirmation item(s) may include any type of suitable file that is readable by the electronic communication device 144, and will cause the electronic communication device 144 to make one or more further requests as confirmation requests to the mobile advertising system 104, which thereby confirms receipt of the content item(s).

In some examples, the confirmation item may play an active role, such as an embedded script or external JavaScript file which submits the confirmation request. However, some types of the electronic communication device 144 may have limited support for JavaScript or have JavaScript turned off. In some examples, the confirmation item(s) may play a passive role such as an image or an external stylesheet. External files such as images or stylesheets that are automatically requested when content item(s) are loaded on the electronic communication device 144 may be reliable when certain features such as scripts or cookies are disabled on the electronic communication device 144. Also, by keeping the size of the confirmation item(s) relatively small, the confirmation item(s) may not significantly affect delivery of the content items.

In some examples, the confirmation item may be appended in such a way that it may only be read after the electronic communication device 144 has received all of the content items that are provided by the mobile advertising system 104. In some examples, if the content item is a webpage, the confirmation item may be an HTML image element located towards the bottom of the webpage, which, in some examples, may be the bottom portion of an HTML document. When the playback module 156 sends a request for the image, it is confirmation that the content items in the webpage prior to the image have been loaded and therefore the electronic communication device 144 was successful in receiving the entire webpage. In some examples, a content item may also act as a confirmation item.

At step 412, the content items are provided over the network 100 to the electronic communication device 144, along with the appended confirmation item(s), to be received by the electronic communication device 144. If the content items are successfully received at the electronic communication device 144, then the electronic communication device 144 will read the content items and the confirmation item(s). The electronic communication device 144 will then make an additional request from or for the confirmation item(s). In some examples, the confirmation item may be read first, for example when the confirmation item is JavaScript code, which when run may keep track of content items as they load, and, after a time out period or upon completion of one or more content items being loaded, the JavaScript code may submit back one or more confirmation messages from the electronic communication device 144 to the mobile advertising system 104. If the content items are not successfully provided to the electronic communication device 144, then the electronic communication device 144 will not make the request from or for the confirmation item(s). In some examples, the confirmation item(s) may submit one or more confirmation messages after a timeout period or interval. Furthermore, the confirmation item(s) may indicate how long the consumer may be viewing or accessing the content items.

At step 416, the network is monitored for a request made by the electronic communication device 144 from or for the confirmation item(s). The advertiser module 108 of the mobile advertising system 104 may carry out the monitoring of the mobile advertising system 104.

At step 420, a request from or for the confirmation item is received at the mobile advertising system 104 from the electronic communication device 144. Since the appended confirmation item(s) are read after one or more content items are provided to and received at the electronic communication device 144, reception of the request signifies that the one or more content items were successfully received by the electronic communication device 144. Alternatively, where the mobile advertising system 104 continues to monitor the network 100 but does not receive a request from or for the confirmation item(s), after a time out period it may be determined that the content items were not successfully received by the electronic communication device 144.

At step 424, which may be optional, confirmation that the content items were received successfully may be relayed from the mobile advertising system 104 back to the electronic communication device 144. In some examples, an item, such as an image, may be provided to the electronic communication device 144 to signify to the consumer that the content items were received successfully. In some examples, the mobile advertising system 104 may provide a response message or an empty or small file to simply fill the request so as to prevent errors or bugs that may occur when the request is not filled.

Being able to confirm successful receipt of the content items may be important in some cases. In some examples, where the advertiser is charged after providing the content items, it may be desirable to confirm that the content items were received before charging the advertiser's account. Otherwise, the advertiser's account may have been charged even though the consumer never received the content items.

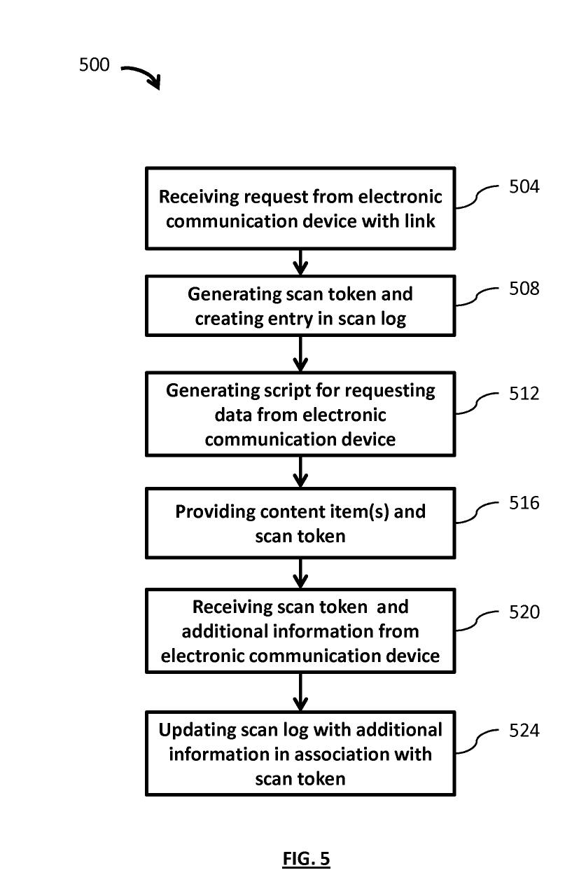

Referring now to FIG. 5, and with continued reference to FIG. 1, an example of a computer-implemented method 500 of tracking consumer access is illustrated. The method 500 includes various steps that may be carried out by the mobile advertising system 104 of FIG. 1.

At step 504, a request for the content items may be received. In some examples, the request may be the link extracted from the mobile tag 146 that has the unique identifier(s) of the content item(s), the mobile advertising campaign, and/or the advertiser. The request received at step 504 may be similar to the request received at step 304 of the method 300, or step 404 of the method 400. The request may be received by the mobile advertising system 104 over the network 100.

At step 508, a scan token is generated. The scan token may allow for identification of the electronic communication device 144 to the mobile advertising system 104. The scan token may be a unique identifier assigned to the consumer using the electronic communication device 144. The scan token may be any suitable item that is capable of being stored in the storage device 160 of the electronic communication device 144, and may be readily identifiable by the mobile advertising system 104. The scan token may be generated by the consumer module 112 of the mobile advertising system 104.

In some examples, the scan token may be sent as a “cookie” that is readable and storable by the playback module 156. In some examples, the scan token may be included in the confirmation item, as described herein. In some examples, if the confirmation item is an image, the scan token may be included in the uniform resource identifier of the image.

The scan token may be stored in the consumer database 132. In some examples, the scan token may be stored along with some or all of the data in the request, additional information or properties derived from data in the request, or additional properties or information retrieved from local or remote databases using data or derived properties from the request. In some examples, data from the request may be submitted to a local or remote database to retrieve information about the electronic communication device 144, including, for example but not limited to, the manufacturer and model, the screen size, the screen resolution and/or other hardware specifications.

An entry may be made into a scan log that stores the scan token and information related to the scan token. In some examples, the scan log may be stored within the consumer database 132. The scan log may include entries associating the scan token with the electronic communication device 144, and may include information about what content items have been provided to the electronic communication device 144, and what data has been received from the electronic communication device 144. In some examples, the scan log may store information received, derived or retrieved similarly to steps 304, 308, 312, 316, and 324 of the method 300.

At step 512, which may be optional, a script for requesting additional data from the electronic communication device 144 may be generated. In some examples, the script may be generated by the consumer module 112 of the mobile advertising system 104. Additional data that may be requested from the electronic communication device 144 may include data obtained from sensors of the electronic communication device 144 including, for example but not limited to, one or more of geographic location, orientation, altitude, and temperature.

It will be understood that the content items themselves may include a means of gathering data from the electronic communication device 144. In some examples, the content items may include a webpage having a form to be completed by the consumer using the electronic communication device 144. The completed form may then be submitted from the electronic communication device 144 to the mobile advertising system 104. In some examples, the content items may include a “buy now” button that may be selected by the consumer, and selecting the “buy now” button may redirect the electronic communication device 144 to third party content. Furthermore, when the “buy now” button is selected, data may be sent from the electronic communication device 144 to the mobile advertising system 104 to indicate that the “buy now” button was selected. This data may then be stored in the storage device 120 in association with the electronic communication device 144 and/or the mobile advertising campaign, and made available to the advertiser.

At step 516, the content items requested by the electronic communication device 144 and the scan token generated at step 508 are provided to the electronic communication device 144. If a script for requesting data is generated at step 512, this may also be provided to the electronic communication device 144. The content items to be provided to the electronic communication device 144 may be determined according to the method 300.

At step 520, the electronic communication device 144 optionally submits or requests data from the mobile advertising system 104. In some examples, data may include confirmation that the content item(s) were received by the electronic communication device 144. In some examples, the data may be GPS coordinates. In some examples, the data may be text or media files provided by the consumer, and the data may include information about the consumer including, for example but not limited to, name and email address.

At step 524, the scan log may be updated to store any additional data gathered from the electronic communication device 144 in relation to the scan token. Thus, in some examples, consulting the scan log may allow for retrieval of the data received in association with the electronic communication device 144.

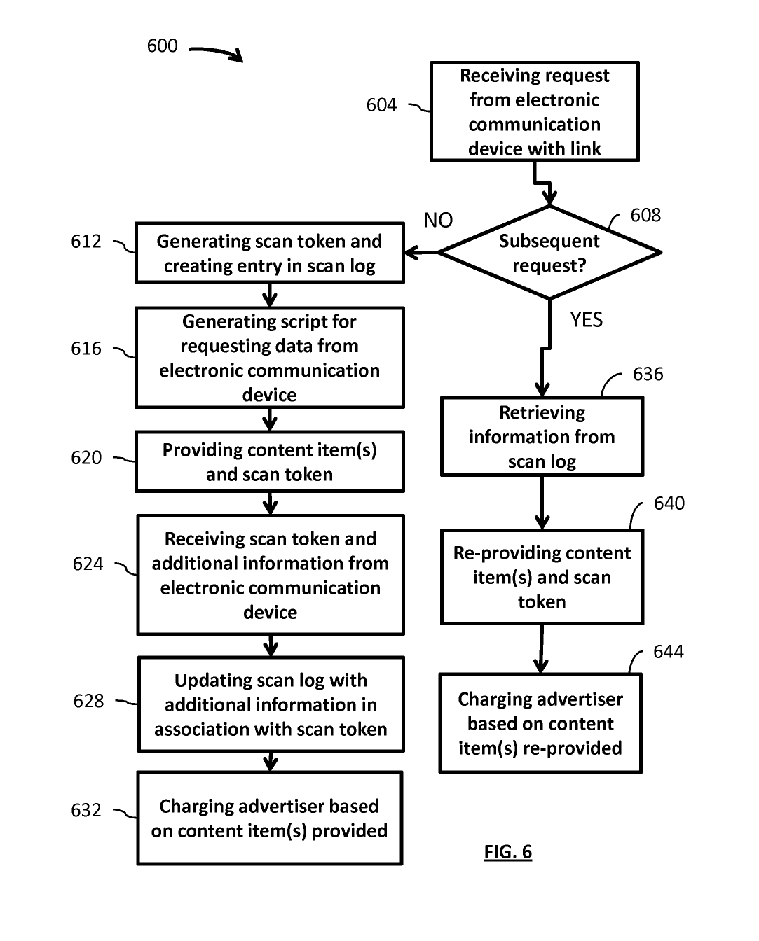

Referring now to FIG. 6, and with continued reference to FIG. 1, an example of a computer-implemented method 600 of tracking consumer access and selectively charging the advertiser is illustrated. The method 600 includes various steps that may be carried out by the mobile advertising system 104.

At step 604, a request for the content items may be received. In some examples, the request may be the link extracted from the mobile tag 146 that has the unique identifiers(s) of the content item(s), the mobile advertising campaign, and/or the advertiser. The request received at step 604 may be similar to the request received at step 304 of the method 300, or step 404 of the method 400, or step 504 of the method 500. The request may be received by the mobile advertising system 104 over the network 100.

The request may include indication of an existing scan token that was previously provided and is stored on the electronic communication device 144, in the storage device 160, for example. In some examples, when the playback module 156 of the electronic communication device 144 makes a subsequent request for the content items through the link, the scan token may also be indicated within the request sent to the mobile advertising system 104. Thus, the scan token may be used by the mobile advertising system 104 to determine past activities of the electronic communication device 144, so as to track the content items provided to it and the data sent to the mobile advertising system 104 previously. In some examples, when the playback module 156 of the electronic communication device 144 makes a subsequent request for the content items through the link, a list of content items or mobile advertising campaigns that were accessed may be indicated within the request sent to the mobile advertising system 104. Thus, the content items that were accessed in a previous request may be immediately apparent to the mobile advertising system 104.

At step 608, if there is indication of a previous request for the content items or mobile advertising campaign, in some examples, information is obtained or derived from the request similar to step 308 of the method 300. In some examples, indication of a previous request may come in the form of a scan token. Furthermore, the scan token may reference additional information from an entry that may be made into a scan log that stores the scan token, similar to the entry made into the scan log described in step 508 of the method 500. Moreover, the scan log may indicate that the electronic communication device 144 has been used previously to access the content items, and the method 600 proceeds to step 636. Otherwise, if there is no indication of a previous request for the content items or mobile advertising campaign, then the electronic communication device 144 has not been used previously to access the content items, and the method 600 proceeds to step 612.

Steps 612, 616, 620, 624 and 628 may be generally similar to steps 508, 512, 516, 520 and 524, respectively, of the method 500. At step 632, after the content items are provided to the electronic communication device 144, the advertiser's account may be charged, which may be generally similar to step 324 of the method 300.

If, at step 608, the existing scan token is detected, step 636 involves retrieving information about the electronic communication device 144 from the scan log. Step 636 may be optional. In some examples, the consumer module 112 of the mobile advertising system 104 may communicate with the consumer database 132 to find the entry in the scan log corresponding to the existing scan token. In some examples, the information stored in the scan log may determine which of the content items have already been provided to the electronic communication device 144. In some examples, the consumer module 112 of the mobile advertising system 104 may communicate with the consumer database 132 to find a list of content items or mobile advertising campaigns already accessed by the electronic communication device 144, or references to unique identifiers for said content items or mobile advertising campaigns.

At step 640, it may be determined whether the content items requested in the request received at step 604 need to be re-provided to the electronic communication device 144. In some examples, if the content items had previously been provided and received, and are stored in cache of the storage device 160 of the electronic communication device 144, the requested content items may not need to be provided again. Alternatively, if the electronic communication device 144 no longer has the content items, they may be provided again. Furthermore, if requested content items have been updated or modified, the updated content items may be re-provided.

At step 644, the advertiser's account may be charged based on the content items provided again at step 640. Step 644 may be optional. In some examples, if no content items were provided at step 640, the advertiser's account may not be charged at all. In some examples, if only previously provided content items are re-provided at step 640, the advertiser's account may be charged a first amount. This first amount may be less than the amount that is charged at step 632 for providing the requested content items to the electronic communication device 144 for the first time. In some examples, if new or updated content items are provided at step 640, the advertiser may be charged a second amount. This second amount may be more than the amount that is charged if the requested content items were merely re-provided. However, in some examples, the second amount charged for providing updated content items may still be less than the amount charged at step 632 for providing content items to the electronic communication device 144 for the first time. Various billing structures are possible.

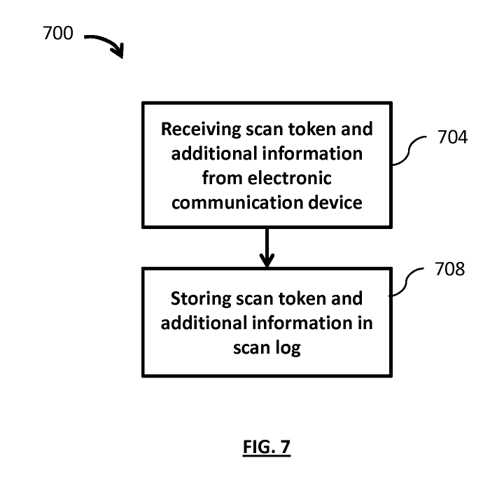

Referring now to FIG. 7, and with continued reference to FIG. 1, an example of a computer-implemented method 700 of receiving and storing tracking data from the electronic communication device 144 is illustrated. In some examples, steps 704 and 708 may be generally similar to the steps 520 and 524 of the method 500.

At step 704, data submitted from an electronic communication device 144 is received, along with tracking data stored in the electronic communication device 144. In some examples, the tracking data from the electronic communication device 144 may encompass the scan token and/or a list of previously accessed content item(s). In some examples, the electronic communication device 144 may submit data in response to receiving the script for requesting data generated at step 512 of the method 500, or step 616 of the method 600. The data submitted may be received by the consumer module 112 of the mobile advertising system 104.

As described herein, the mobile advertising system 104 may utilize the scan token to relate the electronic communication device 144 to the consumer and scan information (e.g., which content item(s) were previously accessed by that consumer). However, in some examples, the mobile advertising system 104 may use data of the previously accessed content item(s), without the scan token, which may serve to determine if it is a subsequent request, and prevent duplicate charges to the advertiser. This may be the arrangement in examples where the mobile advertising system 104 does not track consumer information, but simply charges for providing access to content items.

Information pertaining to the electronic communication device 144 may be optionally retrieved from the scan log. In some examples, the consumer module 112 of the mobile advertising system 104 may search the consumer database 132 to find the entry in the scan log corresponding to the scan token identified in the request. In some examples, data received from electronic communication device 144 in step 704 may be entered into the scan log without regard for previous entries. This may be useful in cases where an advertiser may want to see a history of requests for content items.

At step 708, the data submitted from the electronic communication device 144 that is received by the mobile advertising system 104 is stored. In some examples, the data submitted may be stored in the consumer database 132. In some examples, a new entry in the scan log may be created (e.g., when the scan token does not already exist in the scan log, or when the system is tracking a history of submissions). In some examples, an existing entry with a scan token matching the submitted scan token may be updated with the newly submitted information.

Where data submitted from more than one of the electronic communication device 144 is stored in the consumer database 132, the data may be used as an analysis tool for the advertiser. In some examples, where data submitted includes GPS location information for the electronic communication device 144, at the time the mobile tag was scanned, the advertiser may analyze this data to determine which of its mobile tags were scanned most frequently, and which locations experienced the highest visibility. This information may be made available to the advertiser over the network 100 as raw data, or may be compiled and presented to the advertiser in the form of a report.

The data submitted from the electronic communication device 144 that is stored at step 708 may be associated with the scan token and the unique identifier(s) for the mobile advertising campaign. In some examples, the data from the electronic communication device 144 may be associated with the scan log entry for the scan token. Where data is uniquely associated with the electronic communication device 144, such as a purchase order made through the electronic communication device 144, reading the scan log will allow further retrieval of information related to the purchase order. In some examples, data submitted from the electronic communication device 144 that is stored at step 708 may be stored as part of the scan log. In some examples, the advertiser's account may be further charged based on the data submitted from the electronic communication device 144. Accordingly, the amount charged may be based on the type of consumer information included in the data submitted from the electronic communication device 144.

The data submitted by the electronic communication device 144 along with the scan information may be presented in a tabular or graphical format to the advertiser through the advertiser module 108. The data may include various information about the consumers, including geographic information, personal information and purchasing information. This information may be made available to the advertiser through the scan log accessible by the mobile advertising system 104.

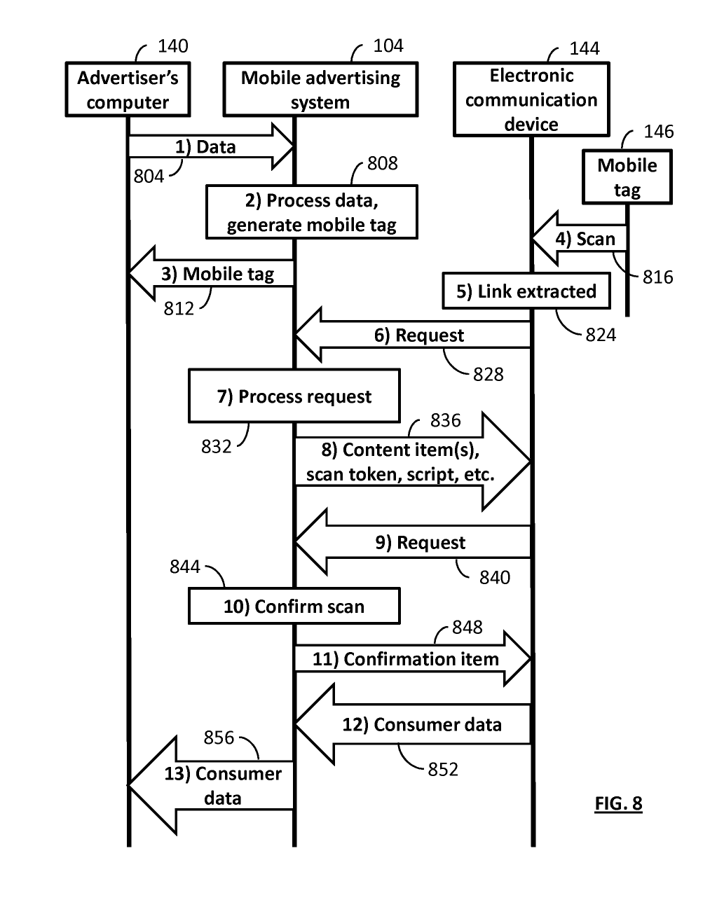

FIG. 8 illustrates the flow of information between the various components connected to the network 100 of FIG. 1, and is intended to provide further understanding of the teachings herein but not limit the present disclosure.

At action 804, as described in relation to steps 204 and 208 of the method 200, the advertiser from the advertiser's computer 140 sends its login information and selections of local content and options, which are received at the mobile advertising system 104. At action 808, as described in relation to steps 212 to 232 of the method 200, the received content is used by the mobile advertising system 104 to create at least one content item and to generate a mobile tag. At action 812, as described in relation to step 236 of the method 200, the mobile tag may then be made accessible to the advertiser's computer 140.

At action 816, the mobile tag 146 in the marketplace may be scanned by the scan module 148 of the electronic communication device 144. At action 824, the electronic communication device 144 reads the mobile tag to extract the link. The link may include the unique identifier(s) for the content item(s), the mobile advertising campaign, and/or the advertiser. At action 828, as described in relation to step 304 of the method 300, step 404 of the method 400, step 504 of the method 500, and step 604 of the method 600, the request from the electronic communication device 144 is received at the mobile advertising system 104.

At action 832, as described in relation to steps 308 to 316 of the method 300, the content item(s) to be provided to the electronic communication device 144 are determined by the mobile advertising system 104. In addition, as described in relation to step 408 of the method 400, a confirmation item may be appended to the content item(s). As described in relation to step 508 of the method 500, a scan token may also be generated.

At action 836, as described in relation to step 320 of the method 300, the content items are provided to the electronic communication device 144. The confirmation item, the scan token, and, as described in relation to steps 512 and 616, the script for requesting data may all be provided or delivered to the electronic communication device 144. At action 840, as described in relation to step 420 of the method 400, the electronic communication device 144 may send a request based on the confirmation item.

At action 844, the request may be received at the mobile advertising system 104, and thereby confirm that the content item(s) has been successful received by the electronic communication device 144. At action 848, as described in relation to step 424 of the method 400, the confirmation item, which may be a script or item that would trigger a request for an external file, may be provided to the electronic communication device 144.

At action 852, as described in relation to step 704 of the method 700, the electronic communication device 144 may submit data to the mobile advertising system 104. At action 856, the received data may be presented to the advertiser's computer 140.

The teachings of the present disclosure may offer a number of advantages over existing approaches to implementing mobile marketing campaigns, including the following.

First, in accordance with some examples of the present disclosure, the advertiser does not need to be as concerned with making the advertising content display properly on the electronic communication device. Characteristics of the electronic communication device may be utilized to tailor the content provided to the consumer, or alternatively the advertiser may select a template that is optimized for the targeted electronic communication device(s).

Second, in accordance with some examples of the present disclosure, the advertiser may not need to use a third party to generate the mobile tags for propagating the advertising content. This may reduce the possibility for error, for example, where a mobile tag is distributed that does not work due to an incorrect link.

Third, the mobile tags generated in accordance with some examples herein need not be proprietary. QR codes, for example, do not require a proprietary mobile application to access the encoded link. This may increase the likelihood that the consumer already has a software application on the electronic communication device that is capable of reading the mobile tag, which increases the number of consumers that may read the mobile tag quickly without having to download a proprietary mobile tag reader.

Fourth, some examples of the present disclosure may allow the advertiser to use a recognizable mobile tag (e.g., a QR code), which may influence consumers to use that mobile tag to get more information from the advertiser, rather than using a more generic method to obtain information (e.g., using a search engine, or an application that searches by part number or Universal Product Code (UPC)), where they may encounter competitors.

Finally, some examples of the present disclosure do not use a database to look up a link based on a UPC or another barcode (where the link points to another server where more information may exist). In contrast, the mobile tag as described herein may be more understandable to the consumer than a UPC, so that the consumer may be more likely to recognize that they may scan the mobile tag. The mobile tag specifies the link, which again may be recognizable by a third party application and need not be a specific proprietary application.

It should be appreciated that the examples of the systems and methods described herein may be implemented in hardware or software, or a combination of both. However, these examples may be implemented in computer programs executing on programmable computers, each including at least one processor, a data storage system (including volatile and non-volatile memory and/or storage elements), at least one input device, and at least one output device. For example and without limitation, the programmable computers may be a mainframe computer, server, personal computer, laptop, personal data assistant, cellular telephone, smartphone, or tablet device. Program code is applied to input data to perform the functions described herein and generate output information. The output information is applied to one or more output devices in known fashion.

Furthermore, each program may be implemented in a high level procedural or object-oriented programming and/or scripting language to communicate with a computer system. However, the programs may be implemented in assembly or machine language, if desired. In any case, the language may be a compiled or interpreted language. Each such computer program may be stored on a memory, such as, for example: magnetic media, like a hard disk, a floppy disk, or other magnetic disk, a tape, a cassette tape; optical media, like an optical disk (CD-ROM, digital versatile disk-DVD); semiconductor media, like DRAM, SRAM, EPROM, EEPROM, a memory stick, or by any other media readable by a general or special purpose programmable computer for configuring and operating the computer when the storage media or device is read by the computer to perform the procedures described herein. Optionally, the memory is distributed across different media. The system may also be considered to be implemented as a computer-readable storage medium, configured with a computer program, where the storage medium so configured causes a computer to operate in a specific and predefined manner to perform the method steps described herein.

Moreover, the system and methods of the described examples are capable of being distributed in a computer program product including a computer readable medium that bears computer-usable instructions for one or more processors. The medium may be provided in various forms including one or more diskettes, optical media, like an optical disk (CD-ROM, digital versatile disk-DVD), tapes, chips, wireline transmissions, satellite transmissions, internet transmission or downloadings, magnetic and electronic storage media, digital and analog signals, and the like. The computer-usable instructions may also be in various forms including compiled and non-compiled code.

While the above description provides examples of one or more apparatuses or methods, it will be appreciated that other apparatuses or methods may be within the scope of the accompanying claims.

I claim:

1. A computer-implemented method of providing mobile advertising over a network, comprising:
receiving data from an advertiser regarding a mobile advertising campaign;
creating at least one content item based on the data, and making the at least one content item accessible over the network;
generating a mobile tag comprising a link to the at least one content item, and making the mobile tag available to the advertiser;
in response to a consumer reading the mobile tag with an electronic communication device, providing the consumer with access to the at least one content item over the network; and
charging the advertiser based on the consumer accessing the at least one content item.

2. The method of claim 1, wherein the at least one content item comprises first and second content items, and further comprising selecting which of the first and second content items to provide access to.

3. The method of claim 2, wherein the step of selecting comprises determining at least one device property of the electronic communication device, and selecting which of the first and second content items to provide access to based at least in part on the device property.

4. The method of claim 2, wherein the step of selecting comprises determining at least one account property of an account of the advertiser, and selecting which of the first and second content items to provide access to based at least in part on the account property.

5. The method of claim 2, wherein the step of charging comprises:
charging the advertiser a first value amount based on the consumer accessing the first content item; and
charging the advertiser a second value amount based on the consumer accessing the second content item.

6. The method of claim 5, wherein the first content item is a full-featured content item, and the second content item is a limited-featured content item.

7. The method of claim 1, further comprising assigning at least one unique identifier to the at least one content item, and wherein the link comprises the at least one unique identifier.

8. The method of claim 1, wherein the at least one content item comprises a scan token for identification and tracking of the electronic communication device.

9. The method of claim 1, further comprising identifying if tracking data is stored on the electronic communication device indicating that the consumer previously accessed the at least one content item.

10. The method of claim 9, further comprising, if the tracking data is not identified, generating new tracking data to be stored on the electronic communication device.

11. The method of claim 10, further comprising:
providing with the at least one content item a confirmation item that sends a confirmation request or triggers a confirmation request; and
receiving the request from the electronic communication device over the network so as to confirm that the electronic communication device accessed the at least one content item.

12. The method of claim 11, wherein the confirmation item comprises an image.

13. The method of claim 12, wherein the at least one content item comprises a webpage, and the image is located towards a bottom visible portion of the webpage.

14. The method of claim 13, wherein a uniform resource identifier of the image comprises the tracking data.

15. The method of claim 11, wherein the confirmation item comprises at least one of an embedded script and an external file.

16. The method of claim 15, where the external file comprises at least one of an image, a stylesheet, and a JavaScript file.

17. The method of claim 11, wherein the step of charging is completed once the request for or a submission from the confirmation item has been received.

18. The method of claim 1, further comprising making consumer information regarding the consumer available to the advertiser.

19. The method of claim 18, wherein the consumer information comprises at least one of geographic information, personal information and purchasing information.

20. The method of claim 18, further comprising:
requesting at least a portion of the consumer information from the electronic communication device over the network; and
receiving the consumer information from the electronic communication device over the network.

21. The method of claim 18, wherein, in the step of charging, the advertiser is charged at least in part based on the consumer information.

22. The method of claim 21, wherein, in the step of charging, the advertiser is charged at least in part based on receiving the consumer information.

23. The method of claim 1, wherein the at least one content item comprises at least one of an image, text, video, audio, a webpage, a script, and a form.

24. The method of claim 1, wherein the at least one content item comprises a content item hosted by a third party.

25. The method of claim 1, wherein the mobile tag comprises at least one of a 2D barcode, an NFC tag, and a computer readable image.

26. The method of claim 1, wherein the at least one content item comprises a webpage, the link comprises a uniform resource identifier of the webpage, and further comprising:
in response to the consumer reading the mobile tag with the electronic communication device, receiving a request comprising the uniform resource identifier of the webpage; and
providing the consumer with access to the webpage over the network.

27. A system for providing mobile advertising over a network, comprising:
a processor; and
a computer-readable storage medium storing code that when executed by the processor carries out the steps of:
receiving data from an advertiser regarding a mobile advertising campaign;
creating at least one content item based on the data, and making the at least one content item accessible over the network;
generating a mobile tag comprising a link to the at least one content item, and making the mobile tag available to the advertiser;
in response to a consumer reading the mobile tag with an electronic communication device, providing the consumer with access to the at least one content item over the network; and
charging the advertiser based on the consumer accessing the at least one content item.

28. A computer program product comprising a computer-readable storage medium storing processor executable code for providing mobile advertising over a network, the code when executed carries out the steps of:
receiving data from an advertiser regarding a mobile advertising campaign;
creating at least one content item based on the data, and making the at least one content item accessible over the network;
generating a mobile tag comprising a link to the at least one content item, and making the mobile tag available to the advertiser;
in response to a consumer reading the mobile tag with an electronic communication device, providing the consumer with access to the at least one content item over the network; and
charging the advertiser based on the consumer accessing the at least one content item.
